(19) United States
(12) Patent Application Publication
(10) Pub. No.: US 2008/0127280 A1
(43) Pub. Date: May 29, 2008

(54) Method and system for ranking videos / movies or other objects, and inserting commercial advertisements in the objects

(76) Inventors: Shaobo Kuang, Lansdale, PA (US); Yinan Kuang, Lansdale, PA (US)

Correspondence Address: SHAOBO KUANG, 1243 Meadowview Circle, Lansdale, PA, 19446, US

(21) Appl. No.: 11/985,189

(22) Filed: Nov. 14, 2007

Related U.S. Application Data
(60) Provisional application No. 60/860,983, filed on Nov. 27, 2006.

(51) Int. Cl. H04N 7/173; H04N 7/10

(52) U.S. Cl. 725/86; 725/34

(57) ABSTRACT

The present invention relates to method and system for ranking videos/movies, and inserting commercial advertisements in the videos/movies. When a user selects a movie or video from Internet, system will allow him to select advertisements, and insert the advertisements into the movie or video before or during broadcasting or downloading. During playing or watching the movie or video, the inserted advertisements will send signals back to a ranking server. Based on the received signals, the ranking server will rank the movie or the video.

The present invention is based on the provisional Patent Application, Ser. No. 60/860,983, filed on Nov. 27, 2006, titled “Method and System for ranking videos/movies or other objects, and inserting commercial advertisements in the objects”.

### FIELD OF THE INVENTION

This invention relates to the techniques for analyzing a linked database. More particularly, it relates to methods and system for assigning ranks to objects, such as movies, videos, pictures, web live show, chat rooms, chat persons, or on-line games, and inserting commercial advertisements into the objects.

### BACKGROUND OF THE INVENTION

Thanks to Google and Yahoo, we feel much better than before when we search for information (web site or documents) through the Internet. Now, due to the recent growth in popularity of broadband and high-speed Internet, 3G wireless connections throughout the world and many kinds of web objects other than pure text web pages are getting more popular and taking more and more internet traffic. Examples are as videos, flash/stream broadcasting, video stream broadcasting, voice broadcasting, music file like mp3, short text messages, live shows, chat rooms, net meetings, on-line games, etc. Also everyone can now make/produce these web objects and then publish them to the public. MySpace.com and YouTube.com have become the new big players in Internet. Recently, there have been large numbers of people who have started to frequently search huge databases for not only the web pages but also videos, chat rooms, net jokes, games, and other objects. Information retrieval methods & systems for these kinds of objects are mostly judged by number of the views and reader's rating. Since not many people really spend time to express their ratings on objects that they have viewed back to the publishers, the quality of the results produced by these search engines is, somehow, often neglected.

Search engines presently use many techniques to generate more relevant objects in their search results. Typically, objects like videos, pictures, or chat rooms, are ranked according to variations of a predefined model. These variations could be 1) how close the search terms match the description of the objects, and/or 2) how many times the objects have been viewed or downloaded, and/or 3) the readers' ratings on the objects. These rules provide search results that are better than they are without any ranking. However, the results are still in relatively low in quality, especially with so many new amateur videos and pictures and other objects that are published by non-professional people every day. Since the Internet market is highly competitive, everyone wants to put their objects at the beginning of the search results. It often results in search results that contain artificially made commercial appeals made by so-called “spamming” techniques and should not be considered a match to the query stream.

Google has successfully used the so-called “back link” methods for ranking static web pages. However, so far, there is still no effective way to rank objects like videos, pictures, chat rooms, live shows, games, and etc. Many sites, including YouTube and Google Video, use rating systems that allow viewers to rate out of a certain number how good the video was, but this method is often inaccurate. Most people will not bother to rate a video after viewing it, considering this action a waste of time, and many people will not get a chance to rate the videos if he or she does not like it and does not finish viewing. Another method, used by myspace.com and youtube.com, is to display objects by times viewed/downloaded. Excluding videos that employ “spamming” techniques, this, however, will put the old videos or pictures at an advantage over the newly published videos or pictures, even if the newly published videos are much better than the old ones.

There are many commercial advertisements during playing movies or videos. With in-stream advertisements the ad can play before the video clip plays, a placement known as pre-roll; after the video clip plays, called post-roll; or somewhere in the middle of the video clip, known as a mid-roll or interstitial ad. Video ads are typically 15 seconds or 30 seconds in length. For the banner typed advertisements or post-roll typed advertisements, people just ignore those ads if they are not interested in them. However, advertisements embedded in the videos or movies, especially the so-called mid-roll advertisements, often not only bother the people who watch the videos or movies, but also waste their time and even cause them to stop watching the videos or movies. Because of the lack of the information about the people viewing the objects, most of those commercial advertisements are just a waste of both the advertiser's money and the viewer's time. For example, a four-member family, the youngest of which is a teenager, watches TV together and the commercial advertisement shows a baby's diaper or the baby foods. This will have no effect on the family wanting to buy baby products.

There are many free or discount movies or videos in Internet. In return for providing free or discount movies or videos through Internet, the movie or video providers will put some commercial advertisements in their movies or videos. However, there is no best or easy answer of what kind of commercial advertisements should be good or suitable to the people who will watch the movies or videos.

Before, people watched movies or videos mainly from TV, and there were not too many choices. Now, people can watch movies or videos from they PC, or even their cell phone, through the Internet they can find or select their favorite programs from thousands movie/video resources. Before, if you didn't like the movies or videos on TV from all the available channels, you had no choice. Now, if people don't like the movie or video, they just stop watching it and start to find another one. Since so many movies or videos are available, people will not spend time watching the movies or videos that do not interest them. Even for the advertisements, people really don't want to waste time on watching the commercial advertisements that do not relate to them.

### SUMMARY OF THE INVENTION

It is therefore the objects of the present invention are intended to overcome the drawbacks of the conventional art.

Accordingly, an object of the present invention is to provide a method and a system to rank and classify the objects, such as videos, movies, on-line games, net chat rooms, net live shows, and etc.

Another object of the present invention is to provide a method and a system to gather data about the length of time the people spend on watching a movie, a video, or the like.

Another object of the present invention is to provide a method and a system to rank and classify the objects, such as videos, movies, on-line games, net chat rooms, net live shows, by taking consideration of the average time of the people watching on, viewing, staying with or playing with it.

Another object of the present invention is to provide a method and a system to broadcast or download the videos or the movies with the advertisements matched the customers/clients profiles.

Another object of the present invention is to provide a method and a system to put specific commercial advertisements on the movies, videos, or shows for the real targeted people.

Another object of the present invention is to provide a method and system to dynamically insert some small advertisements into the videos or the movies when broadcasting or downloading.

Another object of the present invention is to provide a method and system to dynamically insert some small advertisements, based on the customers/clients profile or selection, into the videos or the movies during broadcasting or downloading.

Another object of the present invention is to provide a method and a system to allow the people to select what kind of commercial advertisements will be played on the movies or videos they will watch.

Another object of the present invention is to provide a method and a system to rank the movie or video objects by star characters who play in the selected advertisements.

Further objects and advantages of our invention will become apparent from a consideration of the drawings and ensuring description.

A video/movie method according to the present invention includes:
customers/clients select videos or movies;
before or during the broadcasts or downloads of the selected videos or movies, insert small sectors into the videos or movies;
during playing of the videos or movies, the said small sectors will cause to send signals to a ranking server;
the said ranking server counts the signals, and calculates the time each client spends watching the videos or movies, and ranks the videos or movies by taking consideration of the average time the clients spend on watching them.

A video/movie method according to the present invention includes:
customers/clients request videos or movies;
customers/clients select their favorite advertisements;
before or during the broadcasting or downloading the selected videos or movies, based on the customers/clients selection, insert one or more small;
broadcast or download the videos or movies to the customers/clients.

A video/movie system according to the present invention includes:
means for hosting videos or movies;
means for broadcasting/downloading videos or movies to customers or clients;
means for storing the customers/clients information, such as login id, passwords, favorite videos or movies;
means for inserting one or many small sectors into the videos or the movies before or during broadcasting/downloading the videos or the movies;
means for ranking the said videos or movies;

wherein during playing the of the videos or movies, the said inserted small sectors send signals to the said ranking means; and the said ranking means rank the videos or movies by taking the considerations of the signals received.

A video/movie system according to the present invention includes:
means for hosting videos or movies;
means for broadcasting/downloading videos or movies to customers or clients;
means for storing the customers/clients information, such as login id, passwords, favorite videos or movies, and favorite advertisements;
means for inserting one or many small pieces advertisement shows into the videos or the movies before or during the broadcast/download of the videos or the movies based on the favorite advertisements or the selection of the advertisement by the customers/clients who download or watch videos or movies;

### BRIEF DESCRIPTION OF THE DRAWINGS

FIG. 1 illustrates a prior art video/movie broadcasting system.

FIG. 2 illustrates an example of the present invention.

FIG. 3 is a diagram illustrating an example of the present invention.

FIG. 4 is a diagram illustrating another example of the present invention.

FIG. 5 is a diagram illustrating another example of the present invention.

FIG. 5a illustrates an example of the membership system of the present invention.

FIG. 5b illustrates an example of the videos/movies management system of the present invention.

FIG. 5c illustrates an example of the table list of advertisements according to the present invention.

FIG. 6a is a table showing an example of the objects ranking according to the present invention.

FIG. 6b is a table showing an example of the objects ranking according to the present invention.

FIG. 7 shows workflow according to the present invention.

FIG. 8 shows an example of the selection list of the advertisements according to the present invention.

FIG. 9A shows an example of ranking movies or videos.

FIG. 9B shows an example of ranking movies or videos.

### DETAILED DESCRIPTION

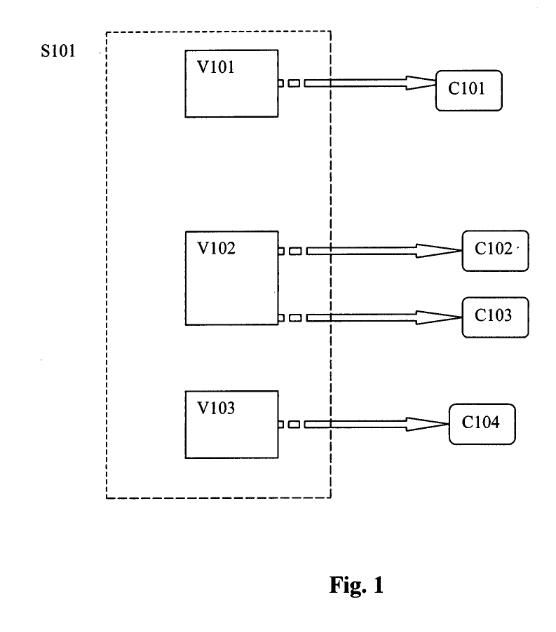

FIG. 1 shows a prior art video or movie broadcasting/downloading system. S101 is a host/server, which broadcasts videos, movies or other shows, V101 and V102, to its clients, C101, C102, C103, and C104 . . . through the Internet. The movies V101 and V102 can be broadcasted from the different servers. The clients C101, C102, C103 and C104 are connected to the server S101 through the Internet. It may be wired or wireless.

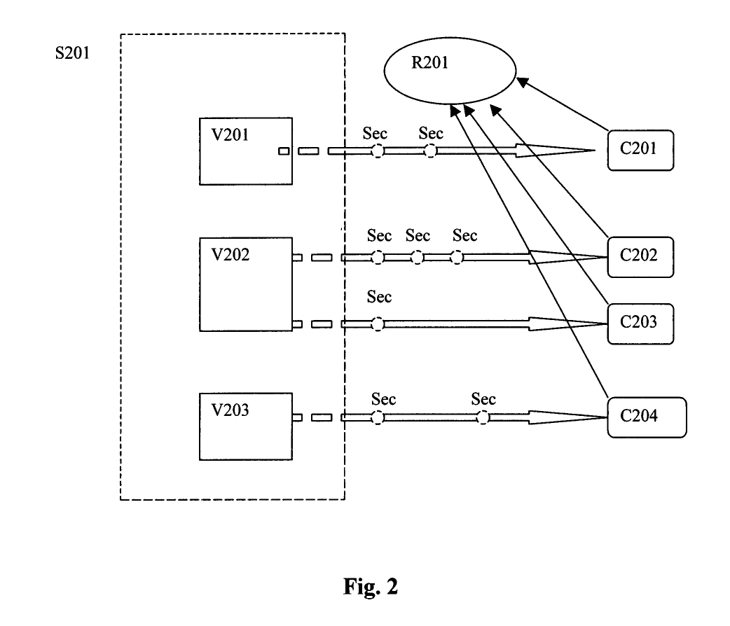

FIG. 2 shows an example of video or movie broadcasting/downloading system in accordance with the present invention. S201 is a host/server, which broadcasts stream broadcasts, videos, movies or other shows, V201, V202, and V203, to its clients, C201, C202, C203, and C204. The clients C201, C202, C203 and C204 are wired or wireless connected to the Internet, and then through the Internet connected the server S201. In the videos or movies, V201, V202, and V203, there are many pre-inserted small sectors. When the video or movie plays, the said small sectors will cause to send signals to the ranking server R201 through Internet. The ranking server R201 will count and calculate the time each client spends watching the video or movie, and will rank videos or movies by taking consideration of the average time the clients spend on watching them. The pre-inserted small sectors may be a small sector of videos or movies, like small advertisements.

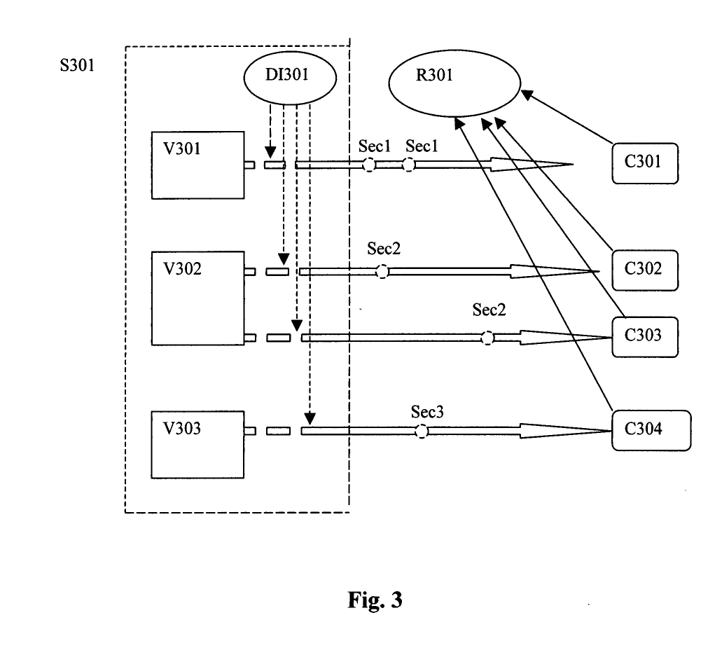

FIG. 3 shows another example of a video or movie broadcasting/downloading system in accordance with the present invention. S301 is a host/server, which broadcasts, such as stream broadcasts, videos, movies or other shows, V301, V302, and V303, to its clients, C301, C302, C303, and C304. The clients C301, C302, C303 and C304 are wired or wireless connected to the Internet, and then through the Internet connected the server S301. DI302 is a device to dynamically insert (DI) many small sectors into the videos or the movies before or during the server S301 broadcasts them. When the videos or movies play, the said small sectors will cause to send the signals to the ranking server/system R301 through Internet. The ranking server R301 will count and calculate the time each client spends watching the video or movie, and will rank videos or movies by taking consideration of the average time the clients spend on watching them. The small sectors, which are dynamically inserted into the videos or movies by DI301, may be some small piece sub-videos or movies, such as small commercial advertisements. DI301 will dynamically insert many small sectors, such as small commercial advertisements into the videos or movies before or during the broadcasting/downloading time based on the user's information, such as geography or time information. For example, one user is in New York City while the other one is in Chicago. They may get two different kinds of commercial advertisement shows each targeted to their respective locations.

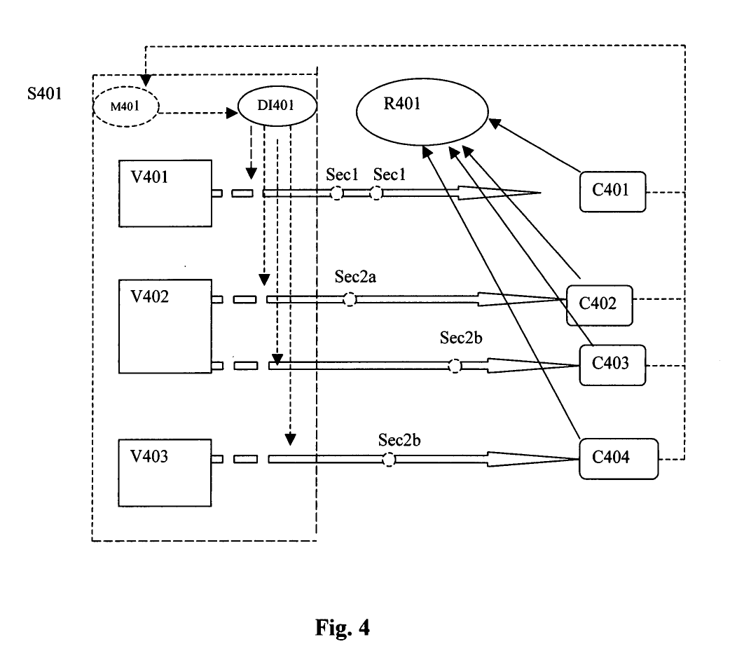

FIG. 4 shows another example of a video or movie broadcasting/downloading system or a video-on-demand system in accordance with the present invention. S401 is a host/server. M401 is a membership management system. Clients C401, C402, C403, and C404 log in to the said membership system M401 first, which is in or connected to the server S401. Based on the client's request, the clients will download or the server will broadcast the requested videos or movies, V401, V402, and V403, to its clients, C401, C402, C403, and C404. DI401 is a device to dynamically insert (DI) many small sectors into the videos or the movies before or during the broadcast/download. In this example, the DI401 will be based on the client's profile/preferred or the clients selection, to selectively insert the many different small sectors into the videos or the movies V401, V402, V403, and V404. When the videos or movies play, these small sectors will cause to send the signals to the ranking server R401. The ranking server R401 will count and calculate the time each client spend on (watching) the video or movie, and will rank videos or movies by taking the consideration of the average time the clients spends watching them. The small sectors, which are dynamically inserted into the videos or movies by DI401, may include some small sectors of sub-videos or sub-movies, such as commercial advisements. For example, from the user's profile, the membership system M401 knows that the clients C403 and C404 are interested in NBA and they are 76ers fans. When they download and watch the videos or movies, the DI401 inserts a small sector sec2b, which is a short commercial advertisement for promoting the 76ers season tickets, into the videos V403 and V404. For the same video or movie V402, the client C402, when login to system, tells M401 that he likes a movie star, Tom Cruise, very much. Even when watching commercial advertisement shows on the movies or videos, he wants to watch any commercial advertisements starring Tom Cruise. Then, the M401 instructs DI401 to dynamically insert many small sectors, sec2a, which are the commercial advertisements starring Tom Cruise.

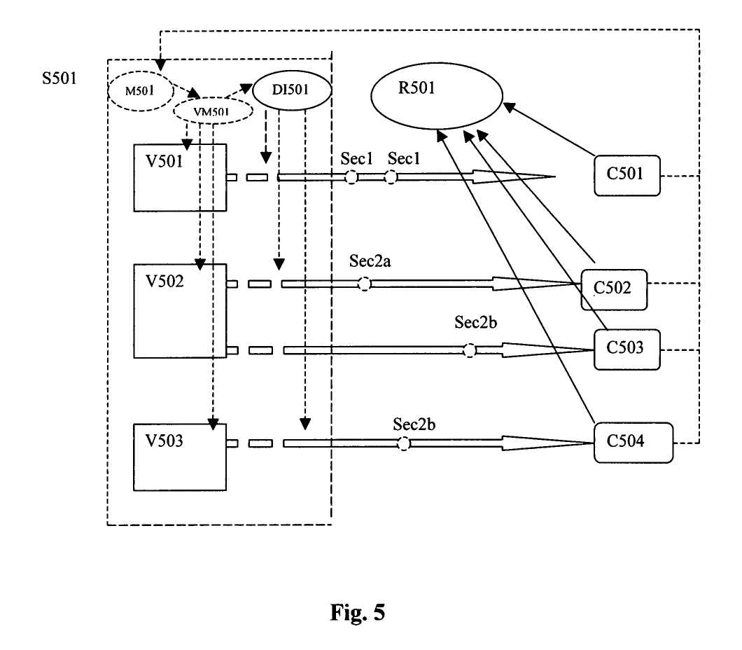

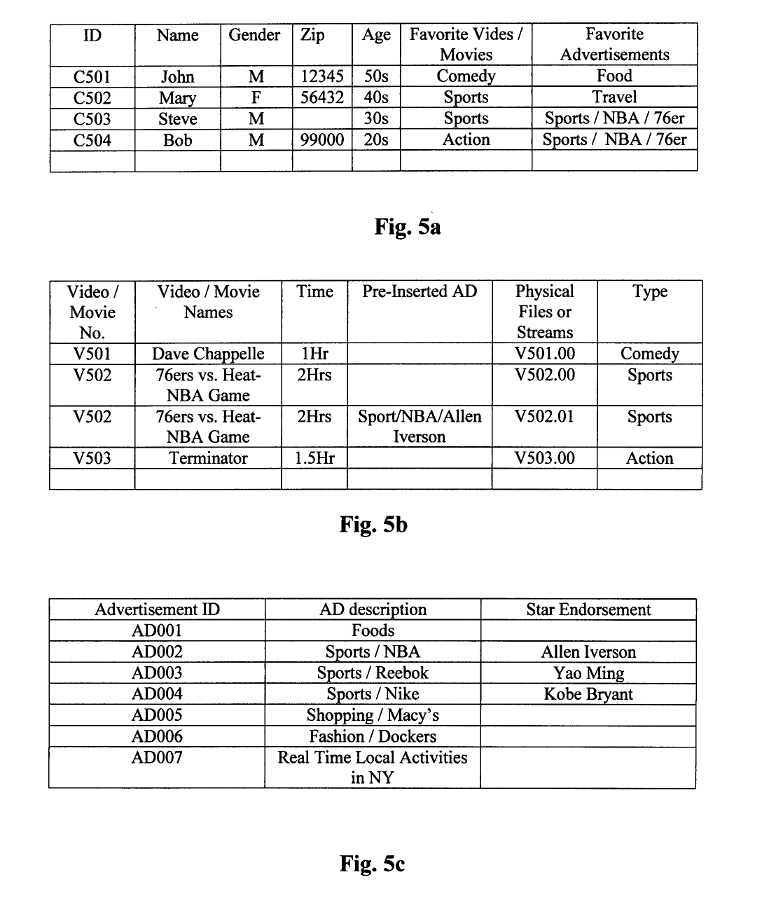

FIG. 5 shows another example of a video or movie broadcasting/downloading system or a video-on-demand system in accordance with the present invention. S501 is a host/server. M501 is a membership management system, which stores the information about the clients or customers, such as the names, professions, educations, races, genders, their favorite videos or moves, and their favorite advertisement choices. Clients C501, C502, C503, and C504 log in to the said membership system M501 first, which is in or connected to the server S501. Based on the client's request, the clients will download or the server will broadcast the selected videos or movies, V501, V502, and V503, to its clients, C501, C502, C503, and C504. The videos V501, V502, and V503 may be video streams for broadcasting or the file for users downloading, VM501 is video/movie management system. VM501 stores the information for the video or the movie stored in the server S501 (or even stored in the other servers). The information may include the name of the video, the movie or shows, total time of playing, and the information about the pre-inserted advertisements if it has. DI501 is a device to dynamically insert (DI) many small sectors into the videos or the movies before or during the broadcasting/downloading. If there are no pre-inserted advertisements match the customer's preference or the customer's selection, then VM501 will ask DI501 to dynamically insert (DI) many small sectors, based on the customer's preference or the customer's selection, into the videos or the movies during or just before the broadcasting/downloading. In this example, the DI501 will be based on the client's profile/preferred or the client's selection, to selectively insert the many different small sectors into the videos or the movies V501, V502, V503, and V504. During the videos or the movies, these small sectors will send the signals to the ranking server R501. The ranking server R501 will count and calculate the time each client spend on (watching) the video or movie, and will rank videos or movies by taking the consideration of the average time the clients spends watching them. The small sectors, which are dynamically inserted into the videos or movies by DI501, may include some small sectors of sub-videos or sub-movies, such as the commercial advisements. In this example, from the user's profile or from the user's selected advertisements, the membership system M501 knows that the clients C503 and C504 are interested in NBA and they are Denver Nuggets fans, and want to the advertisements starring their favorite player, Allen Iverson. The system checks VM501 and sees whether or not V502 and V503 contain pre-inserted advertisements starring Allen Iverson. If yes, system will direct broadcast/download the V502 and V503 to the customers C503 and C504 respectively. Otherwise, before or during broadcasting/downloading, the DI501 will insert the small sectors sec2b, which is a short commercial advertisement for promoting Reebok shoes starring Allen Iverson, into the videos V503 and V504. For the same video or movie V502, the client C502, when login to system, tells M501 that he wants the advertisements regarding the real time local activities, and his is current located in New York City. Then, the system instructs DI501 to dynamically insert many small sectors, sec2a, which are the commercial advertisements regarding the real time activities in New York City, such as fashion shows in Fifth Avenue, and music concerts at Lincoln Center this weekend, and etc.

FIG. 5a shows an example of the membership management system M501 in FIG. 5. From the table, the system knows that the user C501 is a 50-year-old male named John whose zip code is 12345 and prefers comedy videos and food advertisements. User C502 is a 40-year-old female named Mary whose zip code is 56432 and prefers sports videos and travel advertisements. User C503 is a 30-year-old male named Steve who has not listed his zip code and prefers sports videos and advertisements for the Philadelphia 76ers. User C504 is a 20-year-old male named Bob whose zip code is 99000 and prefers action videos and advertisements for the Philadelphia 76ers.

FIG. 5b shows an example of the videos or movies management system VM501 in FIG. 5. V501 is a 1-hour comedy video of Dave Chappelle with no pre-inserted ad that user C501 in FIG. 5a prefers. V502 is a 2-hour sports video of a 76ers vs. Heat NBA game with no pre-inserted ad that user C502 in FIG. 5a prefers. However, user C503 from FIG. 5a is also watching V502 and it does contain a pre-inserted 76ers advertisement that C503 prefers, so the advertisement is transmitted to him. V503 is a 1.5-hour action video of “The Terminator” with no pre-inserted ad that user C504 in FIG. 5a prefers.

FIG. 5c shows an example of the video or movie list in DI501 in FIG. 5. AD001 is food ad with no particular star endorsement. AD002 is a sports/NBA ad starring Allen Iverson. AD003 is a sports/Reebok brand ad starring Yao Ming. AD004 is a sports/Nike brand ad starring Kobe Bryant. AD005 is a shopping/Macy's ad with no particular star endorsement. AD006 is a fashion/Docker's ad with no particular star endorsement. AD007 is an ad of local activities in New York with no particular star endorsement.

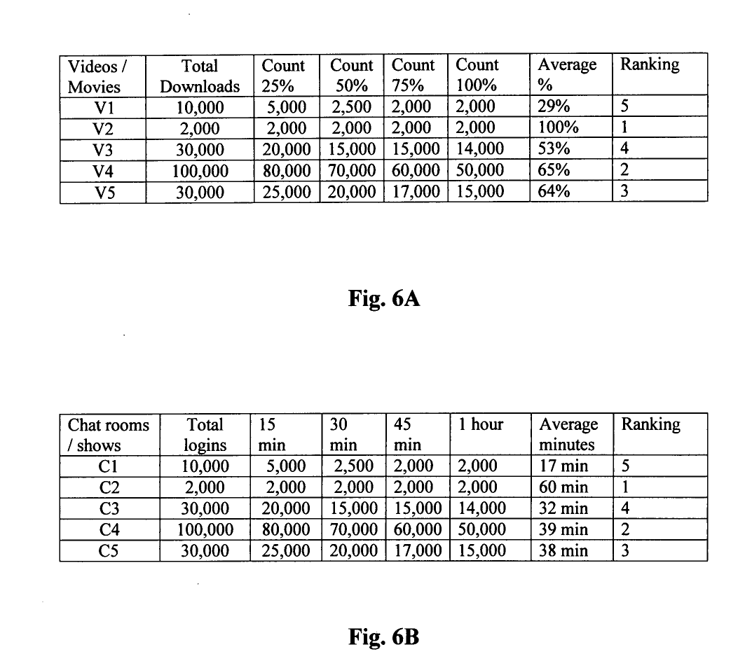

FIG. 6a is a table showing an example of the objects ranking according to the present invention. The first column in the table lists the names of the movies or videos. The second column in the table lists the corresponding total downloads or broadcasts of the movies or videos in the first column. The third column shows the counts at the 25% of the total playing time of the movies or videos. The fourth column shows the counts at 50% of the total playing time of the movies or videos. The fifth column shows 75% of the total playing time of the movies or videos, the sixth column shows the how many people/clients have completed watching the movies or videos. In the table, there are 30,000 downloads or broadcasts for the movie or video V3, which will last, for example, 2 hours, and 20,000 people/clients are still watching on V3 after 25% of the total playing time, 30 minutes. In another words, 10,000 people/clients stop watching on V3 after minutes 30 minutes. The seventh column shows the average percentage people watching on the movies or videos. For video or movie V1, people average only complete 29% of it. For video or movie V2, all the people finished watching on it. For video or movie V3, people on average complete 53% of it. For video or movie V4, people on average complete 65% of it. For video or movie V5, people on average complete 64% of it. Therefore, V2 ranks No.1, V4 ranks No. 2, V5 ranks No. 3, V3 ranks No. 4, and V1 ranks No. 5.

FIG. 6b is a table showing another example of the objects ranking according to the present invention. The first column in the table lists the names of the chat rooms. The second column in the table lists the corresponding total logins for the chat rooms in the first column. The third column shows the total counts after 15 minutes spent in the chat room by the user. The fourth column shows the total counts after 30 minutes spent in the chat room by the user. The fifth column shows the total counts after 45 minutes spent in the chat room by the user, the sixth column shows the total counts after 1 hour spent in the chat room by the user. In the table, there are 30,000 logins for chat room C3, and 20,000 people/clients are still logged in after 15 minutes spent in the chat room. In another words, 10,000 people/clients log out of C3 after minutes 15 minutes. The seventh column shows the average time people spend in the chat rooms. For chat room C1, people only spend 17 minutes logged in on average. For chat room C2, all the people stayed logged in for at least 1 hour. For chat room C3, people spend 32 minutes logged in on average. For chat room C4, people spend 39 minutes logged in on average. For chat room C5, people spend 39 minutes logged in on average. Therefore, C2 ranks No.1. C4 ranks No. 2. C5 ranks No. 3. C3 ranks No. 4, and C1 ranks No. 5.

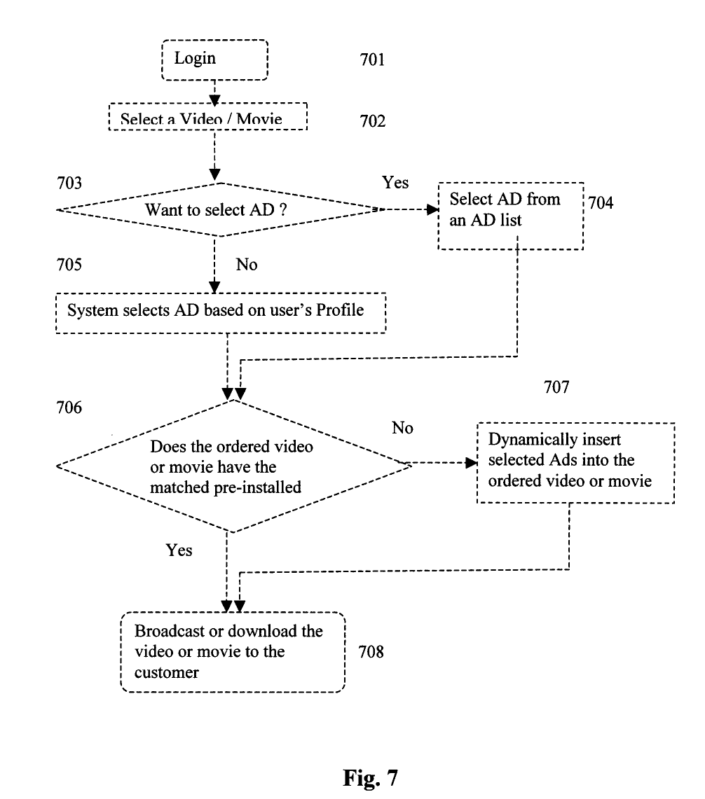

FIG. 7 is a flow chart showing the method to which advertisements are inserted into the user's selected video. In step 701, the users log in to the membership system, wherein the user's profile information is stored. In step 702, the users select videos or movies they want to watch. In step 703, the users are asked whether they would like to select their favorite commercial advertisements in their videos or movies. If yes, in step 704, they will be prompted for a selection list for their selecting advertisements. Otherwise, in step 705, the system selects ads based on the information in the user's profile. In step 706, system checks whether or not the videos or movies already have a pre-installed ad that matches the user's preferences are available. If yes, no change is made to those advertisements, and the system directly goes to step 708. If no, in step 707, the system dynamically inserts advertisements matching the user's preferences into the videos or movies. In step 708, the system broadcasts or downloads the videos or movies to the users.

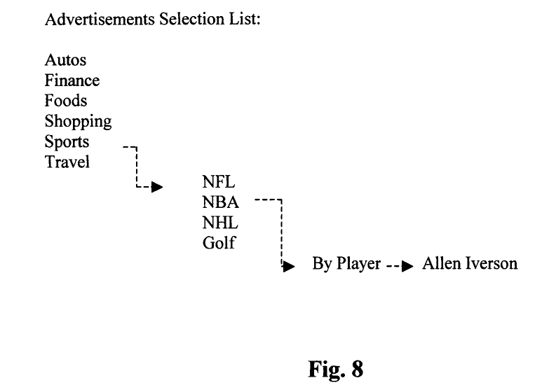

FIG. 8 is a drawing showing the hierarchical structure of selecting the user's preferences for advertisements. First, the user is asked which of the broad categories is his preferred one. Second, the category that is picked is split into subcategories and in this case, the user has selected sports and its subcategories are NFL, NBA, NHL, and golf. The user then selects NBA and chooses to browse by player and selects Allen Iverson.

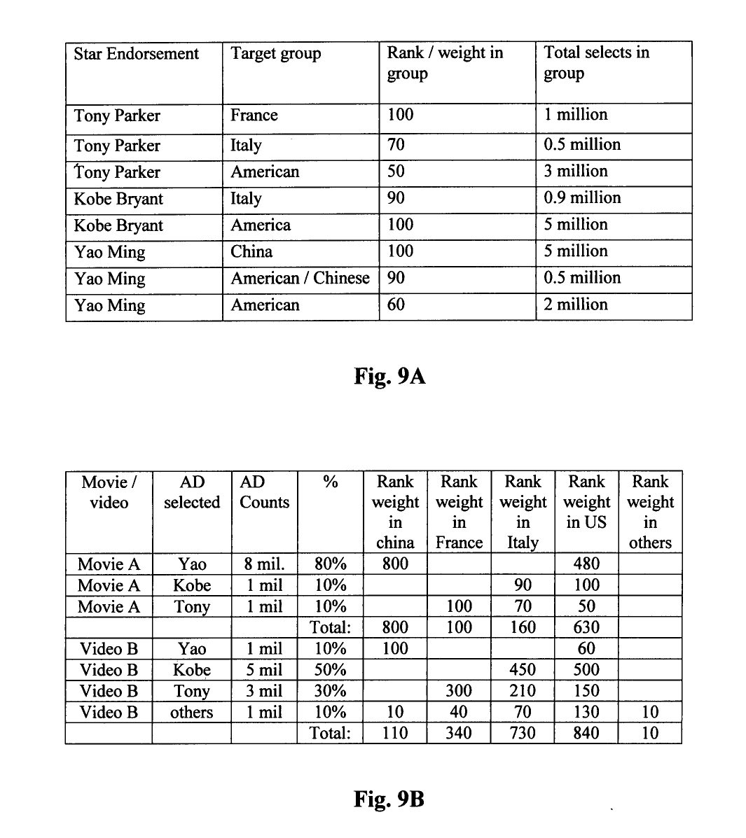

FIG. 9 is a table shows another example of ranking. FIG. 9A shows that different stars have a different rank weight/power in different regions or groups. For example, Tony Parker, the NBA player, has a rank weight/power 100 in France, 70 in Italy and 50 in America. Yao Ming has a rank weight/power 100 in Chi. 90 in America/Chinese group and 60 in America. FIG. 9B shows an example of ranking movie or video by stars. For movie A, people select 8 million of Yao's advertisements, 1 million of Kobe's advertisements, and 1 million of Tony's advertisement. For movie B, people select 1 million of Yao's advertisements, 5 million of Kobe's advertisements, 3 million of Tony's advertisement, and 1 million of other stars. By applying FIG. 9A, multiplying the group weight or power in FIG. 9A by AD counts in FIG. 9B, movie A has a rank weight/power 800 in China, 100 in France, 160 in Italy, 630 in US, video B has a rank weight/power 110 in China, 340 in France, 730 in Italy, 840 in US, and 10 in other groups.

From FIG. 9A and 9B, we can see how the users can select to include their favorite stars, for example sport stars, playing/appearing in the advertisements when they watching movies or videos. Therefore, those stars could be paid by how many users select them.

Although the above detail descriptions contain many specifics for the purposes of illustration, one of ordinary skill in the art will appreciate that many variations and alterations to the above details are within the scope of the invention. Accordingly, the above embodiments of the invention are set forth without any loss of generality to, and without imposing limitations upon, the claimed invention.

1. A method for broadcasting and ranking movies or videos according to the present invention includes:
customers/clients select videos or movies;
before or during the broadcasting or downloading the selected videos or movies, insert small sectors into the videos or movies;
during playing of the videos or movies, the said small sectors will cause to send signals to a ranking server;
the said ranking server counts the signals, calculates the time each client spends watching the videos or movies, and ranks the videos or movies by taking consideration of the average time the clients spend on watching them.

2. A video/movie system according to the present invention includes:
means for hosting videos or movies;
means for broadcasting/downloading videos or movies to customers or clients;
means for storing the customers/clients information, such as login id, passwords, favorite videos or movies;
means for inserting one or many small sectors into the videos or the movies before or during broadcasting/downloading the videos or the movies;
a server or system for ranking the said videos or movies;
wherein, the said small sectors further include means for sending signals back to the said ranking server during the time of playing movies or videos; and the said ranking server/system further includes means for collect the signals and calculate the time the people watching on the movies or the videos, and rank the videos or movies by taking the consideration of relative average time people watching on the movies or the videos.

3. The system of claim 2 wherein the said small sectors are commercial advertisements.

4. The system of claim 3 wherein the ranking server or system includes means for receiving the user's selection of advertisements, and means for inserting the user's selected advertisements into the movies or videos.

5. A method for inserting or putting commercial advertisement into movie or video comprising:
under control of a client system,
displaying movies or videos for selecting;
displaying commercial advertisements for selecting;
submitting the selections;
in response to the submit, sending the selected movie or video and the selected advertisements with other user's information to a server system;
under control of a movie or video server system,
receiving the request,
retrieving the selected movie or video with pre-inserted selected advertisements;
if the said retrieving failed, then retrieving the selected movie or video and the selected advertisements, and inserting the selected advertisements into the selected movie or video;
broadcasting or allowing the user to downloaded the retrieved movie or video to the said client.

6. The method of claim 5 wherein the displaying of advertisements includes:
displaying the groups or categories of advertisements, such as by the products the advertisement promoting for, or by the stars who plays or appears in the advertisements.

7. The method of claim 6 further comprises:
under control of the said client system,
during playing the movie or the video, the inserted advertisements send signals back to a ranking server;
under control of the said ranking server,
collecting the signals from movies or videos, and counting the time spent on watching movies or videos,
assigning ranks to movies or videos based on the counts.

8. The method of claim 7 further includes:
based on the favorite level of a star in the particular regions, using the number of the people selecting the star to rank the movies or videos the people selected.

9. The method of claim 8 further includes:
Giving the stars credits based on how many people select them or how many times people select them for movies or videos.
